(19) United States
(12) Patent Application Publication
(10) Pub. No.: US 2023/0351467 A1
(43) Pub. Date: Nov. 2, 2023

(54) LINKING MEDIA TO SPECIFIC ONLINE CALCULATORS

(71) Applicant: Kurt Lloyd Heckman, Friendsville, MD (US)

(72) Inventor: Kurt Lloyd Heckman, Friendsville, MD (US)

(21) Appl. No.: 17/661,027

(22) Filed: Apr. 27, 2022

(51) Int. Cl. G06Q 30/06; G06K 19/06; G06F 16/955

(52) U.S. Cl. CPC G06Q 30/0627; G06K 19/06037; G06F 16/9554

(57) ABSTRACT

A system for providing product-specific calculators comprises a web page having an online calculator configured to enable users to calculate at least one quantity related to a particular product; a QR code disposed in proximity to the particular product and linked to the web page having the online calculator; and an internet-connected device capable of scanning the QR code and directing, based on the scanned QR code, the internet-connected device to the web page having the appropriate online calculator.

### CROSS REFERENCE TO RELATED APPLICATIONS

This application claims the benefit of and priority to U.S. Provisional Patent Application No. 63/187,769, filed on May 12, 2021, entitled “Linking Media to Specific Online Calculators,” the entire disclosure of which is hereby incorporated herein by reference.

### FIELD OF THE INVENTION

This invention relates to the use of quick response (QR) Codes associated with particular products, and more particularly, for the mapping of particular products to product-specific internet-based calculators based on a QR code associated with the particular product.

### BACKGROUND

There are many products available that may need to be purchased in numbers or quantities in order to be used in a project. For example, one must buy several boards (2×4s) to frame a wall, several bags of concrete to pour a concrete slab, many square yards of fabric for an article of clothing, and many pounds and ounces of ingredients for a recipe to feed a large group. In each case, some mathematics may be associated with determining quantities of the product to be purchased.

Product labels are often disposed on both the product itself and on the display or container, such as a shelf or a bin, that holds the product for view by customers. These labels often provide product specifications in addition to the unit and bulk pricing of the product.

The primary method of calculating the amount of product needed was formerly hand calculations. Then tools such as handheld calculators became available and reduced the errors in arithmetic. But the math involved in computing amounts often include specific parameters associated with the product (e.g., 0.5 cubic feet in a bag of play sand) and certain algorithms associated with its use (e.g., the spacing of boards on a deck based on the anticipated carrying load).

In recent years, millions of single function calculators have been developed on the Internet. Instead of using the highly limited set of arithmetic functions on a hand-held calculator, computer programming on the Internet allows for highly specific and sophisticated algorithms that compute or calculate answers to very specific calculating challenges. However, to get to those calculators, one must either know the correct internet address for the calculator or perform an internet search and choose the correct calculator from those provided in the search. This can often result in a random and inaccurate utilization of the wrong calculating tool.

### SUMMARY OF INVENTION

A method of using quick response (QR) Codes to link product labels and other print and digital media to online calculators that are specifically useful in computing the amount of product needed for a project is disclosed herein. To help the consumer purchase the appropriate amount of a product, the calculator can query the user about specific parameters and return a calculated answer based on the product specifications and an algorithm required for the product's utilization.

According to an aspect, a method of providing product-specific calculators may comprise providing a machine-readable image related to a particular product; scanning, with an internet-connected device, the machine-readable image; and directing, based on information from the machine-readable image, the internet-connected device to a website having a product-specific calculator related to the particular product or a class of products that may include the particular product and at least one related product. The machine-readable image may be on a point-of-purchase display; and the particular product may be a retail product. The online calculator may be configured to receive inputs related to the particular product and to compute quantities related to the particular product based on the received inputs. The calculator may be configured to compute quantities of at least one of the particular product and products related to the particular product. The machine-readable image may be on print advertising for the particular product. Additionally, or alternatively, the machine-readable image may be on visible digital advertising, such as television or video presentations, for the particular product. The machine-readable image may be a quick response (QR) code.

According to another aspect, a system for providing product-specific calculators may comprise a web page comprising an online calculator configured to enable users to calculate at least one quantity related to a particular product; and a machine-readable image disposed in proximity to the particular product and comprising data that corresponds, at least in part, to the internet address of the web page having the online calculator. The machine-readable image may comprise an internet address. When scanned by an internet-connected device capable of scanning the machine-readable image, the machine-readable image may direct the internet-connected device to the web page having the online calculator. The machine-readable image may be disposed on a point-of-purchase display of the particular product. The online calculator may be configured to receive inputs related to the particular product and to compute quantities related to the particular product based on the received inputs. The calculator may be configured to compute quantities of at least one product related to the particular product. The machine-readable image may be a QR code.

According to another aspect, a method of providing access to a product-specific online calculator may comprise creating a machine-readable image for a particular product; and displaying product labeling including the machine-readable image in proximity to the particular product or information about the particular product. The machine-readable image may be capable of, upon being scanned by an internet-connected device, directing the internet-connected device to an online calculator specific to the particular product. The product may be displayed for retail sale. The method may further comprise the step of creating product labeling for the particular product containing the machine-readable image. The machine-readable image may be a QR code.

### BRIEF DESCRIPTION OF DRAWINGS

FIG. 1 is a block diagram of the system in accordance with this disclosure;

FIG. 2 illustrates a retail display of a first product;

FIG. 3 illustrates an online Calculator associated with the first product;

FIG. 4 illustrates a label on a package of a second product;

FIG. 5 illustrates an online calculator associated with the second product;

FIG. 6 illustrates a retail display of a third product;

FIG. 7 illustrates an online calculator associated with the third product;

FIG. 8 is a flow chart illustrating a method of providing access to a product-specific online calculator; and

FIG. 9 is a flow chart illustrating a method of providing access to a product-specific online calculator.

### DETAILED DESCRIPTION

In recent years, QR codes have become increasingly common. The QR codes comprise a printed or digital symbol that can be scanned on an optical reader such as those contained in a smart phone or other internet-connected mobile device.

A method and system for providing easy access to product-specific online calculators employing quick response (QR) codes on print and/or digital advertisements, labels and product point-of-sale displays, such as shelves and bins, of a particular product is described herein. The QR codes may provide the address of a website and may direct the internet-connected device's internet browser to the website.

Each QR code may link the particular product to a specific online calculator that may assist the user in calculations that may be typically associated with a product. For example, the calculator for bags of play sand may link to a calculator that calculates how many bags of play sand will fill a sand box having certain dimensions once the sandbox dimensions have been entered into the calculator. In another example, a calculator for tortillas may calculate how many tortillas, how many tomatoes, and how much cheese will feed a party of a certain number of people once the number of people and other parameters have been entered. Thus, the QR code enables the user to use a smartphone or other internet-connected device to scan the QR Code and access a manufacturer- or store-recommended product-specific online calculator. The product-specific online calculator may enable the user to enter information and see a computed result. Furthermore, the QR codes may enable product manufacturers and publishers to connect consumers with an appropriate and safe on-line calculating tool designed to allow them to efficiently and safely calculate the amount of product they need to purchase for a given project without fear of malware or viruses.

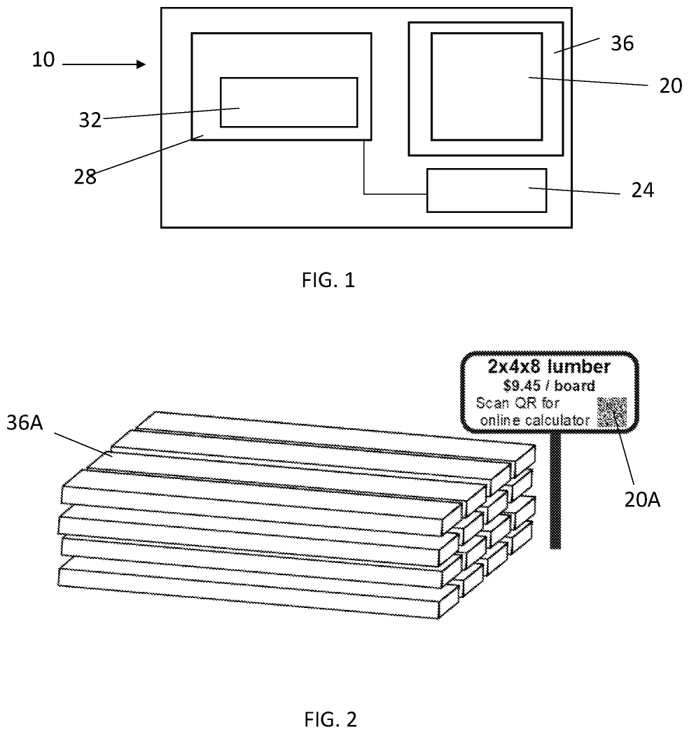

Referring to FIG. 1, the system for providing online calculators to allow consumers to calculate amounts of components is generally shown at reference number 10. The system 10 comprises a machine-readable image such as a QR code 20 or a bar code, an internet-connected device 24 having an optical scanner (not shown) or otherwise capable of reading the QR code, and a web page 28 having an online calculator 32. The internet address of the web page 28 may be encoded in the QR code. In some embodiments, the QR code 20 may be in proximity to and/or associated with a particular product 36. The product may be located at a point of sale such as at a retail or wholesale store. In some embodiments, the QR code 20 may be disposed directly on the particular product 36. In some embodiments, the QR code 20 may be disposed on the display for the product 36, on the shelving holding the product 36, and/or on the product 36 container. In some embodiments, the QR code 20 may be disposed on advertising materials for the particular product 36, such as flyers, print advertisements, and/or digital advertisements. The QR code 20 may be configured to direct an internet-connected device to a web page 28 associated with the particular product 36. The web page 28 may have an online calculator 32 that is specific to the particular product 36. In some embodiments, the product may be located in a warehouse and available, for example, to be ordered online. The QR code may be located in a print or digital advertisement and/or on a web page for the product.

The internet-connected device 24 may be a mobile device such as a smart phone, tablet, or other internet-connected device. The internet-connected device 24 may comprise an optical scanner capable of reading QR codes or may be otherwise capable of scanning QR codes 20 or other machine-readable images.

The web page 28 may include an online calculator 32 specific to the particular product 36. The online calculator 32 may present a user with questions and/or requests for information related to the product 36 and the user's planned use of the product 36. The calculator may further be configured to, based on the results of the information provided by the user, give the user information about quantities of supplies needed for a particular task or project. The online calculator 32 may incorporate requests for information about the characteristics or parameters of the product 36 such as, for example, volumes, areas, lengths, densities, ratios and other characteristics associated with the product 36. The requests for information on the product characteristics may be programmed into the online calculator 32.

The online calculator 32 may be configured to enable a user to input their specific project parameters (e.g., number of guests at a party or dimensions of a garden). The online calculator 32 may use inputs from the user in conjunction with employing an appropriate algorithm to compute the amount of product 36 needed. The online calculator 32 may further be configured to enable a user to choose options on the product specifications (e.g., 40-pound bag of cement versus 60-pound bag).

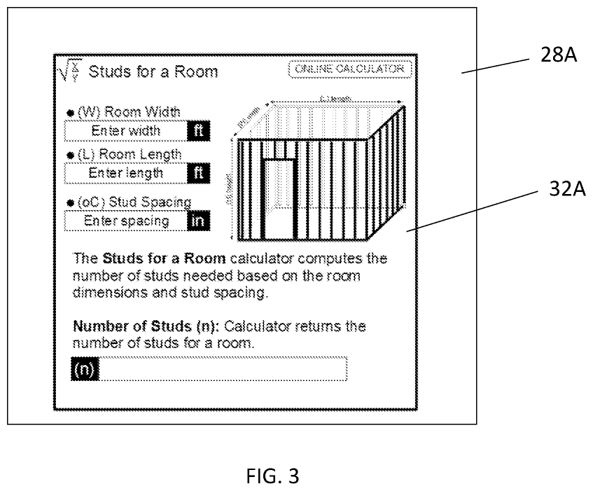

For example, FIG. 2 illustrates a store display of a first product 36A in a store. The display includes the price and size of the first product 36A. A first QR code 20A, may be disposed in proximity to the first product 36A. FIG. 3 illustrates the first online calculator 32A associated with the first product 36A. When scanned by an internet-connected device 24, the first QR code 20A will take a user to a website associated with the first product 36A. The website may have a first web page 28A for a first online calculator 32A associated with the first product 36A. The first online calculator 32A allows a user to enter information based on their project and receive results indicating the amount of the first product 36A that they would need to purchase for their project.

In this example, the first product 36A is lumber used for stud framing in construction. The first online calculator 32A may ask for information such as the dimensions of a room, or building for which the user needs the lumber and the spacing of the lumber. The first online calculator 32A is configured to, once the requested information has been entered into it, return the amount of lumber required for the job according to the parameters described by the data entered. Thus, a user can find a display of a desired product 36A in a store, scan a QR code 20A with an internet-connected device 24, and be taken to a web page 28A having an online calculator 32A that will allow the user to quickly and easily determine the amount of product 36A he or she should purchase for the job.

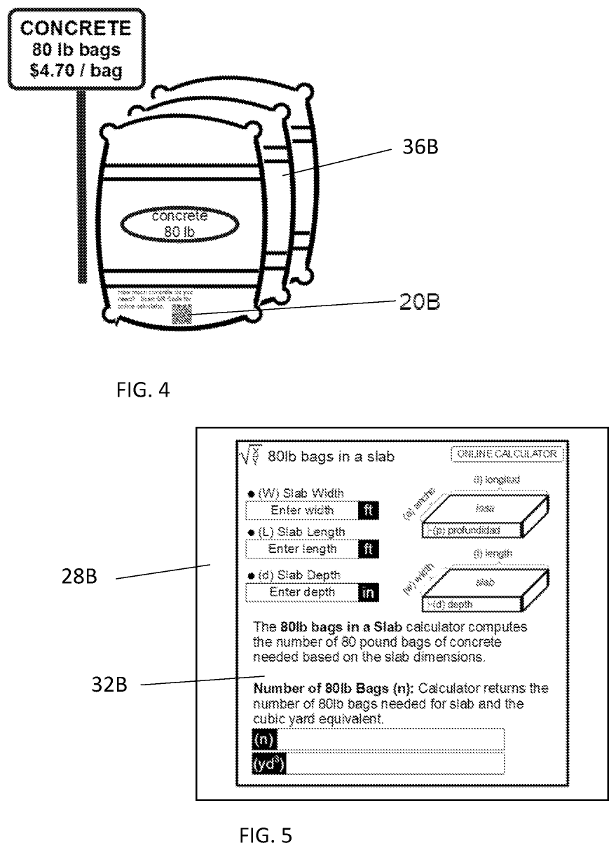

In a second example, FIG. 4 illustrates a container of a second product 36B. A second QR code 20B may be displayed directly on the second product 36B or the packaging of the second product 36B.

The second QR code 20B may be associated with a web page 28B, shown in FIG. 5. The web page may include an online calculator 32B associated with the second product 36B. The second QR code 20B may be disposed on the product container itself or may be located on the store display for the second product 36B. The second online calculator 32B allows a user to answer questions about some of the job parameters and is configured to output the amount of the second product 36B that would be required for the job.

Similar to the example above, a user may use the internet-connected device 24 to scan the second QR code 20B. The second QR code 20B may direct the internet-connected device 24 to the second web page 28B for the second product 36B. The second web page 28B may have a second online calculator 32B. The user may enter information into the second online calculator 32B, and the second online calculator 32B may output the amount of the second product 36B the user would need based on the information entered. In this example, the second product 36B is masonry mix. The second online calculator 32B may ask for inputs on the length, width, and depth of the slab to be built using the masonry mix and is configured to output the number of bags of masonry mix the user should purchase for the project.

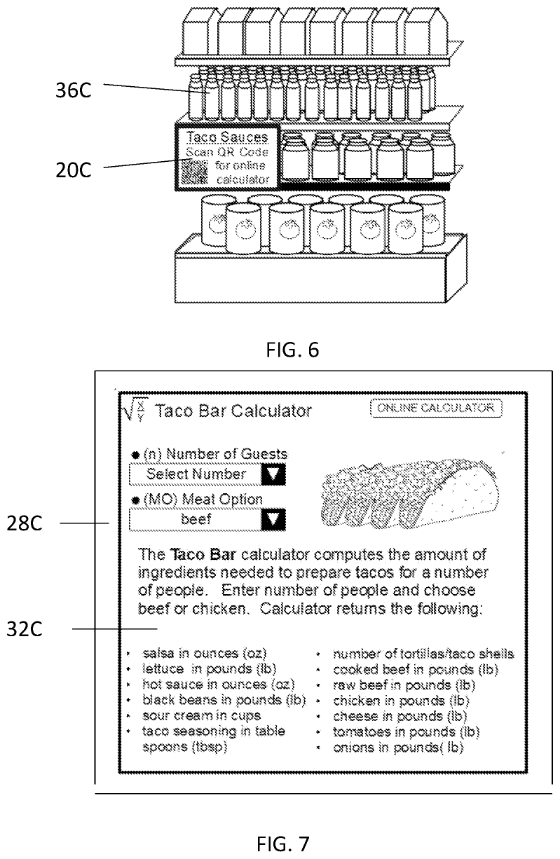

In a third example, FIG. 6 illustrates a store display of a third product 36C. A third QR code 20C may be linked to a web page 28C, shown in FIG. 7, having a third online calculator 32C for the third product 36C. The third QR code 20C may be disposed on a product container and/or disposed on the store shelves on which the product 36C is stored. In this example, the user can scan the third QR code 20C with the internet-connected device 24 and be directed to the third online calculator 32C for the third product 36C. The user may enter information into the third online calculator 32C and receive outputs indicating both how much of the particular product 36C to purchase and quantities of one or more additional products that generally are used in conjunction with the particular product 36C to purchase. For example, the third online calculator 32B may be associated with a food such as tortilla or taco shells that may be part of a meal involving other ingredients. The third online calculator 32B may be configured to ask for inputs on things like the number of guests and the type of meat to be served with the taco shells. Once the information is entered, the third online calculator 32B may be configured to output the number of tortillas or taco shells needed to be purchased for the number of guests entered, along with the amounts of other ingredients, such as meat, cheese, and tomatoes, that should be purchased.

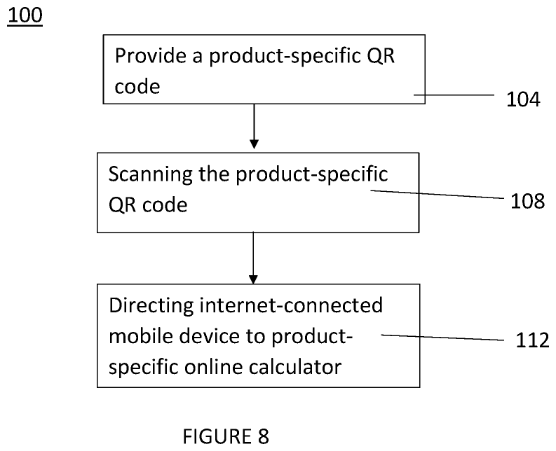

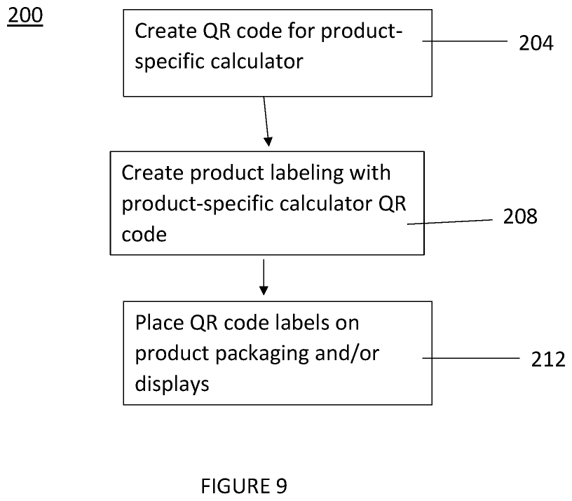

FIG. 8 illustrates a method 100 of accessing a product-specific online calculator 32. The method may comprise providing a QR code 20 specific to a particular product 36 in step 104. The QR code 20 may be disposed on the particular product 36, in proximity to the particular product 36 such as on a display for the particular product, on or secured to the shelving on which the particular product 36 is stored, or on advertising for the particular product 36. In step 108, the QR code may be scanned using an optical scanner of an internet-connected device. In step 112, the internet-connected device 24 is directed by the information encoded in the QR code to a web page 28 having an online calculator 32 specific to the particular product 36. The QR code 20 may be configured to, when scanned by an internet-connected device 24, direct the internet-connected device 24 to a web page 28 specific to the particular product 36. The web page 28 may include an online calculator 32. The online calculator 32 may be capable of, upon the receipt of inputs relating to the scope of planned use for the particular product 36, outputting amounts of quantities of the particular product 36 needed to complete a project of the planned scope. In some embodiments, the online calculator 32 may further be capable of, depending on the particular product 36, outputting amounts of related products associated with the use or purchase of the particular product 36.

FIG. 9 illustrates a method of providing access to a product-specific online calculator 32. The method 200 includes creating QR codes 20 for a specific product 36 at step 204. The QR code 20 may be capable of, when scanned by an internet-connected device, allowing access to the product-specific online calculator 32. In some embodiments, in step 208, product labels with the product-specific QR code 20 may be created. In step 212, the labels containing the product-specific QR code 20 are associated with the product 36. The labels having the QR code 20 may be disposed in proximity to the product 36. The labels may be disposed on a product display, on a shelf containing the product 36, on a product container, on the product 36 itself, on advertising for the product, or in any other suitable location.

In this document, relational terms, such as first and second, top and bottom, front and back, left and right, vertical, horizontal, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications. Furthermore, it is to be understood that the device may assume various orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood that any described processes or steps within described processes may be combined with other disclosed processes or steps to form structures within the scope of the present disclosure. The exemplary processes disclosed herein are for illustrative purposes and are not to be construed as limiting. It is also to be understood that variations and modifications can be made on the aforementioned methods without departing from the concepts of the present disclosure, and further it is to be understood that such concepts are intended to be covered by the following claims unless these claims by their language expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The invention claimed is:

1. A method of providing product-specific calculators, comprising:
providing a machine-readable image related to a particular product;
scanning, with an optical scanner on a device capable of connecting to the internet internet-connected device, the machine-readable image; and
directing, based on information from the machine-readable image, the internet-connected device to a website having a product-specific calculator related to the particular product.

2. The method of claim 1, wherein the machine-readable image is on a point-of-purchase display; and
wherein the particular product is a retail product.

3. The method of claim 1, wherein the online calculator is configured to receive inputs related to the particular product and to compute quantities related to the particular product based on the received inputs.

4. The method of claim 3, wherein the calculator is further configured to compute quantities of at least one additional product related to the particular product.

5. The method of claim 1, wherein the machine-readable image is on print advertising for the particular product.

6. The method of claim 1, wherein the machine-readable image is on visible digital advertising for the particular product.

7. The method of claim 1, wherein the machine-readable image is a quick response (QR) code.

8. A system for providing product-specific calculators, comprising:
a web page comprising an online calculator configured to enable users to calculate at least one quantity related to a particular product, the web page having an internet address; and
a machine-readable image related to the particular product and comprising data that corresponds, at least in part, to the internet address of the web page having the online calculator;
wherein, when scanned by an internet-connected device capable of scanning the machine-readable image, the machine-readable image directs the internet-connected device to the web page having the online calculator.

9. The system of claim 8, wherein the machine-readable image is disposed in proximity to the particular product.

10. The system of claim 8, wherein the machine-readable image is disposed on a point-of-purchase display of the particular product.

11. The system of claim 8, wherein the online calculator is configured to receive inputs related to the particular product and to compute quantities related to the particular product based on the received inputs.

12. The system of claim 11, wherein the calculator is further configured to compute quantities of at least one product related to the particular product.

13. The system of claim 8, wherein the machine-readable image is disposed on print or visible digital advertising related to the particular product.

14. The system of claim 8, wherein the machine-readable image is a quick response (QR) code.

15. A method of providing access to a product-specific online calculator comprising:
creating a machine-readable image for a particular product; and
displaying product labeling including the QR code in proximity to the particular product or information about the particular product;
wherein the machine-readable image is capable of, upon being scanned by an internet-connected device, directing the internet-connected device to an online calculator specific to the particular product.

16. The method of claim 15, wherein the product is displayed for retail sale.

17. The method of claim 15, further comprising the step of creating product labeling for the particular product containing the machine-readable image.

18. The method of claim 15, wherein the machine-readable image is a quick response (QR) code.
